(19) United States
(12) Patent Application Publication
(10) Pub. No.: US 2014/0280715 A1
(43) Pub. Date: Sep. 18, 2014

(54) REAL TIME REMOTE DESKTOP

(71) Applicant: FIRST PRINCIPLES, INC., Albany, NY (US)

(72) Inventor: Keith A. Raniere, Clifton Park, NY (US)

(73) Assignee: FIRST PRINCIPLES, INC., ALBANY, NY (US)

(21) Appl. No.: 13/841,729

(22) Filed: Mar. 15, 2013

(51) Int. Cl. H04L 29/08

(52) U.S. Cl. CPC H04L 67/10
USPC 709/217

(57) ABSTRACT

A method and system for remotely controlling networked devices in approximately real time, by using two or more nodes and a host device. The network achieves real time speeds by segmenting requests and commands to the host device into packet segments then distributing the packet segments through a network of nodes. Each individual node contributes resources to a resource pool which allows for increased data throughput, greater processing speeds, increased memory and storage space.

### FIELD OF TECHNOLOGY

The following relates to a system and method to access remotely one or more networked devices in real time by using more than one networked device's resources to increase the computing power of the network, thus reducing latency between the devices, and more specifically to embodiments of a remote desktop capable of assigning tasks to networked devices which may be peripheral tasks of a computing device.

### BACKGROUND

Remotely controlling a computing device using a second computing device is becoming an increasingly common feature. Individuals today, more than ever before, possess mobile computing devices which are capable of accessing an internet connection even in some of the most remote destinations in the world. Currently, most mobile computing devices do not presently have the equivalent computing power or resources available to it as more robust desktop computing devices or even laptop computing devices. Accordingly, individuals sometimes prefer to access their larger, less mobile computing devices from their more mobile computing devices. Users may also prefer to store large libraries of files in a single centralized location rather than mobile devices which may lack large enough storage capacity. The strategy of remote access allows individuals to leave large amount of files in a central location on a larger, and less mobile storage device accessible by the desktop or laptop computing device, while at the same time allowing access to the library of files on other mobile computing device a user may own.

Traditional remote desktop applications do not behave in the exact same manner as if the user was working locally on the computing device being accessed on a host device. Often, the manipulating device which is provided access to the host device suffers from latency or data lag between actions on the host device and their response being viewed on the manipulating device. The rate of communication between the host device and the manipulating device may result from a bottleneck in bandwidth, quality of network connectivity, lack of memory, lack of processing power, less than adequate power supplies and extended distances data must travel between the host device and the manipulating device. This latency between providing instructions to the host device, receipt of the instruction and the visible corresponding response received by the manipulating device can result in a choppy, less than ideal user experience that may be untenable to the user experiencing the computing environment.

Therefore, a need exists for a latency free remote desktop application which may remotely access, view and modify non-local computing devices.

### SUMMARY

A first aspect of this disclosure relates generally to a method for remotely accessing a computing device in real time comprising the steps of establishing, by a processor of a computing system a protocol between at least two network nodes, receiving, by the processor, a request by an input device of the computing system, segmenting, by the processor, the request into a predetermined number of packets, transmitting, by the processor, the request to the at least two network nodes, receiving, by the processor, a predetermined number of response packets from the at least two network nodes, reassembling, by the processor, the predetermined number of packets into a response from at least one of the at least two network nodes; and displaying, by the processor, the response from at least one of the at least two network nodes.

A second aspect of this disclosure relates generally to a method for remotely accessing computing devices in real time comprising establishing, by a processor of a computing system, a protocol between at least two network nodes, receiving, by the processor, at least two packet segments generated by at least one of the at least two network nodes, reassembling, by the processor, the at least two packet segments into a request from at least one of the at least two network nodes, performing, by the processor, the request from at least one of the at least two network nodes, generating, by the processor, a response packet, segmenting, by the processor, the response packet into a predetermined number of packet segments; and transmitting, by the processor, at least one of the predetermined number of packet segments to each of the at least two network nodes.

A third aspect of this disclosure relates generally to a system for remotely accessing computing devices in real time comprising at least three node devices communicating via a network, a pool of resources wherein said pool of resources are utilized by at least one of the at least three node devices communicating with each other and at least one of the at least three node devices is manipulating another of the at least three node device.

A fourth aspect of this disclosure relates generally to a system for remotely accessing computing devices in real time comprising at least three node devices communicating via a network and at least one graphical user interface identifying each of the at least three node devices communicating via the network, wherein at least one of the at least three node devices manipulates another node of the at least three node devices through the graphical user interface.

### BRIEF DESCRIPTION OF THE DRAWINGS

Some of the embodiments will be described in detail, with reference to the following figures, wherein like designations denote like members, wherein:

FIG. 1 depicts a block diagram of an embodiment of a remote controlled computing network requesting a response from a host device;

FIG. 2 depicts a block diagram of an embodiment of FIG. 1 receiving a response from a host device;

FIG. 3 depicts a flowchart of an embodiment of a requesting device of a remote controlled computer network receiving and responding to an incoming data packet;

FIG. 4 depicts a flowchart of an embodiment of a relay device of a remote controlled computer network receiving and responding to an incoming data packet;

FIG. 5 depicts a flowchart of an embodiment of a host device of a remote controlled computer network receiving and responding to an incoming data packet;

FIG. 6 depicts a block diagram of an alternate embodiment of a remote controlled computing network wherein multiple requesting devices submit simultaneous requests to a host device;

FIG. 7 depicts a block diagram of an alternate embodiment of a remote controlled computer network wherein multiple requesting devices submit simultaneous requests to two separate host devices.

FIG. 8 depicts a block diagram of an alternate embodiment of a remote controlled computer network sending the same request simultaneously to more than one host device.

FIG. 9 depicts a block diagram of an alternate embodiment of a remote controlled computer network wherein two simultaneous requests are submitted to a host device through relay devices dedicated to each requesting device.

FIG. 10 depicts a block diagram of an alternative embodiment of a remote controlled computer network of FIG. 9, wherein the host device is responding to each requesting device.

FIG. 11 depicts a block diagram of alternative embodiment of a remote controlled computer network which features unidirectional relay devices dedicated to sending requests or receiving responses.

FIG. 12 depicts a block diagram of an embodiment of a computing system.

FIG. 13 depicts an alternate embodiment of a remote controlled computer network including three network nodes in three separate locations manipulating each other.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

FIG. 1 depicts an embodiment of a computer network 100 which may include many devices communicating with each other referred to as nodes. Nodes may be a connection point, redistribution point or a communication endpoint within a network 100. The network established may be a computer network, wherein a at least two computing devices and/or other hardware may be interconnected using communication channels which allow sharing of resources and information. At least one of the devices in a network may send and receive data to and from at least one process residing in a remote device. A network may be set up using any known method for allowing communication between at least two nodes. Embodiments of a network may include a Wi-fi enabled network, a Bluetooth network, a personal area network (PAN), a local access network (LAN), a wide access network (WAN), IEEE 802.1x, an intranet, an internet, an extranet and any combination thereof. A network may also include digital cellular telephone network which may include Global System for Mobile Communications (GSM), General Packet Radio Service (GPRS), cdmaOne, CDMA2000, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/TDMA), Integrated Digital Enhanced Network (iDEN), WiMAX, LTE, LTE advanced, mobile broadband wireless access (MBWA), IEEE 802.20. A network 100 may be publically accessible, private, or virtually private such as a VPN. One method a network may use to restrict undesirable nodes from accessing it may be to require a password in order to connect to the network 100.

In an exemplary embodiment of the disclosed computer network 100, the network 100 may include the following nodes: at least one requesting device 101, at least one relay device 103, 104, 105 and at least one host device 102. A requesting device 101 may be any device capable of being networked to any other device or node and the requesting device 101 may be capable of communicating back and forth with other network nodes. In an exemplary embodiment, the requesting device 101 may remotely control other nodes or devices within the network by sending requests for the nodes or device to act or behave in a specified manner. The node or device which is receiving the communication and acts according to the direction of the requesting device 101 is the host device 102. A requesting device may include, but is not limited to, computing devices such as a personal computers, laptops, servers, tablet computers, cellular telephones, internet or wifi enabled devices including music players such as an ipod®, video game consoles, and television receivers. A requesting device 101 may also include non-traditional devices capable of being networked including for example, “smart appliances” which may be internet or Wi-Fi enabled, such as televisions, refrigerators, washers, dryers, water heaters, furnaces, stoves, lamps, and any other appliance found in a home having a wifi receiver operably connected thereto.

A node is not limited to the devices listed above. A node, may be any computing system 1200. One embodiment of a computing system 1200 is depicted in FIG. 12. In the exemplified embodiment, a computing system may include a processor 1201 which may include a central processing unit (CPU), at least one memory device 1204, 1205 which may store input data 1206 and/or computer code 1207. The input data 1206 may be recalled by the computing system 1200 to perform processes while the computer code 1207 may provide instructions how to perform a task, store files or may direct the computing system 1200 to perform a specific task. A memory device for example may include Random access memory, (RAM), flash or solid state memory, semiconductor memory, or storage devices such as a hard disk drive (HDD). A computing device may also contain one or more an input devices 1202 and/or output devices. An input device may be a piece of hardware or peripheral device used to provide data and control signals to the processor 1201. An example of an input device may include keyboards, mice, scanners, digital cameras, joysticks, gamepads, microphones and touch screens. An output device 1203 on the other hand may be any piece of hardware or peripheral device which may communicate the electronic signals processed by the processor 1201 into a human readable form. An example of an output device may include displays such as a monitors or television, graphical displays, audio devices such as speakers, printers.

In alternative embodiments, a requesting device 101 may be a peripheral device. A peripheral device may be any device which may be used with or alongside computing devices. Examples of peripheral devices may include a mouse, keyboard, monitor, controller, remote controller, hard drive or other storage device, speaker, printer, scanner, copier, CD-ROM, router, and, modem. A requesting device 101 assigned as a peripheral may itself be a computing device assigned to act in a manner similar to a peripheral device. For example, a tablet computer may be assigned to act as a monitor which may display the results of the requesting device's requests of the host device 102. Another example may be a cellular telephone being assigned to control the mouse and keyboard of the host device 102. For instance, the cellular telephone may be capable of supplying requests to the host device to move the mouse cursor in a specific fashion using a touch screen or while the touch screen may also contain a virtual keyboard to input a specific sequence of letters as if a keyboard directly connected to the host device 102 was sending the requests. In one embodiment, depicted in FIG. 13, three network nodes 1301, 1302 and 1303 are connected to shared network 1300. Each network node may be in a separate location broadcasting from a separate or shared Wi-Fi connection 1304, 1305 and 1306. In this exemplified embodiment, one or more of the nodes 1301, 1302, 1303 may be controlling or manipulating another node. In addition, each node manipulating the other node may be an assigned peripheral. For example, Node 1301 may enter the network specifically designating itself as a keyboard peripheral of node 1306. Accordingly, as the node inputs letters and numbers, the resulting output may appear on another designated node 1302, 1303 or all nodes in the network. In addition, while Node 1301 acts as a keyboard, Node 1302 may simultaneously act as another peripheral such as a monitor. All resulting manipulations of Node 1303, may ultimately be viewed on node 1302, including any keyboard manipulations provided by node 1301.

Referring to FIG. 1, a host device 102 may be incorporated into the remote controlled network 100. In an exemplary embodiment, the host device 102 may be any device or apparatus capable of being networked to other nodes in a network 100. A host device 102 may be the component of the remote controlled network 100 that may be controlled, or respond to the requests of a requesting device 101. In the example provided above referencing FIG. 13, Node 3 may be considered the host because it receives and responds to requests of the other nodes 1301 and 1302. A host device may take the form of any of the device, nodes or apparatuses that a requesting device 101 may be. In an exemplary embodiment, a host device 101 may be a computing system 1200 such as a personal computer, laptop, cellular telephone, tablet computer or videogame console. Embodiments of a requesting device 101 may view the output of the host device 102 on the requesting device 101. For example, the requesting device 101 may be equipped with a graphical user interface (GUI) for viewing the output on the host device 102 or the output from the requesting device 101. A graphical user interface may be used to display status updates of the network, including the identity of every node on the network 100. In an alternate embodiment, a GUI may be used to allow the signing on and off of nodes on the network 100. The GUI may also be the method used for a user to connect a node to the network, control a node in a network and/or assign a node to act as a peripheral device of another node.

In an alternative embodiment, a host device's output or response may not affect directly affect the host device itself, but rather a host device 102 may act as a centralized location for controlling other non-requesting devices. For instance, a user may use a cellular phone acting as a requesting device to manipulate a host device into turning on or off a separate network 100 node such as an appliance.

Embodiments of the requesting device 101 may request the host device 102 to perform a specific action and the requesting device 101 may subsequently see the corresponding action performed at the host device 102 on requesting device 101 as if the requesting device 101 had performed the action itself. For example, the requesting device 101 may send a request to the host device 102 to perform a function such as opening, modifying, copying, moving, deleting, viewing and/or closing a file stored on the host device or on the network 100. Subsequently, the host device 102, upon receiving the request, may respond to the requesting device by performing the action requested and then reflecting the change to the file in its response which may be generated by the host device which may be viewable by the requesting device 101. In another embodiment, the changes reflected at the request of the requesting device, may also be viewed by non-requesting nodes in the network. A host device which may be a computing system 1200, after establishing a protocol with other nodes on the network 100, including requesting devices and relay devices may then receive packet segments from the other nodes on the network. These packet segments requesting the host device to perform some sort of action may be reassembled into their original request packet and performed by the host device. The host device may then generate a response packet which may be transmitted to the requesting device. Prior to transmitting the request packet, the host device, similar to the requesting device, may also segment its response packets into a predetermined number of packet segments.

Referring to FIG. 1 and FIG. 2 the remote controlled network 100 may further include one or more nodes acting as relay devices 103, 104, 105. The relay devices 103, 104, 105 may be any number of additional devices, capable of networking with the requesting device 101 and the host device 102. Relay devices 103, 104, 105 may be any device that may qualify as either a requesting device 101 or a host device 102. Embodiments of the relay device 103, 104, and 105 may receive portions or segments of the requesting device's 101 request or portions of the host device's response. The requesting device and the host device may send these requests and responses in the form of data packets 110, 210. The time it takes to send a request to a host device 102 or a response to the requesting device 101 may be decreased by segmenting data packets 110a, 110b, 110c, 110d into several portions or segments which collectively form a full length data packet. A relay device 103, 104, 105 may act as a receiver of requesting or responding data packets 110 from a requesting device 101 or response data packets 210 from a host device 102. By segmenting data packets 110, 210 into several smaller segments and transmitting them across at least one relay devices may increase the transfer speed from requesting device 101 to host device 102, decreasing overall network 100 latency. Sending large amounts of data as smaller pieces over several channels may increase the network throughput compared with a single large piece of equivalent data sent over a single channel to the destination. This is because a small piece of data being processed by many devices may travel through a network faster than a large piece of data processed by a single device. By sending several small pieces of data packets 110a, 110b, 110c, 110d at one time they may arrive at the host device quicker than a single large data packet 110. Therefore, increasing the number of relays 103, 104, 105 may increase the number of channels and may result in an increased number of smaller data packet segments 110a, 110b, 110c, 110d travelling through the network and reaching the host device 102, and thus may decrease latency between requests and responses from the requesting device 101 and host device 102.

Each relay device 103, 104, 105 may also increase the overall processing power of the network 100 by using their own computing resources to receive, process and forward the data packet segments 110b, 110c, 110d to the host device 102. Resources that may be used by the relay devices 103, 104, 105 may include central processing power provided by central processing unit (cpu), additional random access memory (RAM), hard drive space, virtual memory, bandwidth, network throughput and additional electrical power. Once all of the data packets 110a, 110b, 110c, 110d arrive at their final destination, they may be reassembled back into a full length data packet 110 by the host device 102. The additional relay device 103, 104, 105 resources may be used as a resource pool for increasing the overall speed of the network 100. By adding more resources, the overall computing power, and throughput of the network 100 may increase as well. Thus, by increasing the available resources, the amount of time it takes for packets to transfer between the requesting device 101 and the host device 102 may decrease thus decreasing overall network latency and providing remote access of the host device 102 in real time or close to real time.

Each node of the network 100 may be specifically designated into roles of a requesting device 101, relay device 103, 104, 105 or a host device. In this embodiment, a relay device may not make a request or be requested to perform an action other than forwarding requests and responses between the requesting devices and host devices. However, designations of nodes may be flexible and may change depending on a node's role in sending or responding to another node's requests for actions. Each node may request an action from any other node or if other nodes are communicating between each other, the remaining nodes may act as relays to facilitate the communications and provide additional resources to the resource pool. For instance, if a network 100 includes a first node, a second node and a third node, if the first node is seeking to modify a file stored on the second node, the first node may be classified as the requesting device 101 and the second node may be classified as the host device 102. The third node in the example may act as a relay 103 if the first node segments the data packet 110 providing instructions about the modification to the second node's file and forwards a data packet segment to the third node which then forwards the data packet segment to the second node. The roles of the nodes may be reclassified depending on subsequent communications. For example, if the third node in the previous example is subsequently requesting that the first node open a file, the third node may now be classified as the requesting device 101 and the second node may be classified as the host device 102.

In order for various nodes or components to communicate with each other, a network may be set up using any traditionally known means for establishing a network connection between network capable devices. A network may be set up as a public network using an internet protocol such as a public IP address or the network may be a private network or a virtual private network (VPN) which allocates a private IP address that may not be viewable from the publicly used internet. In one embodiment, a network 100 may be established between a plurality of nodes using hardware means such as routers, gateways, bridges, switches, hubs, network interface cards (NIC) and/or repeaters. Software networks may be established between each node of the network 100. Software networking may be achieved by installing an application or program on each node of the network. The software application may allow for control of the network to be decoupled from the node's hardware and instead the software may act as a controller which may assign IP addresses, the function and control of one node over another node, assign nodes as peripherals or direct the flow and forwarding of packets of information between networked nodes. The use of a software defined network may provide an administrator of a network 100 with greater control over network traffic. The network may also be a combination of hardware and software. In one embodiment a network administrator may prioritize or deprioritize certain types of packets. In another embodiment, a network administrator may control packet flow rates or designate certain relays to receive request packets 110 from a requesting device 101 while others may be designated to receive only response packets 210 from the host device 102. In another embodiment, software network may restrict a nodes types of requests based on the node's assignment as a peripheral. For example, a node assigned as a mouse may only be able to send packets instructing the host device 102 to move its mouse cursor or click the mouse buttons, while a peripheral assigned as a keyboard would not be able to control the mouse at all but rather may request that the host device input any one of the keys found on a keyboard.

Embodiments of a network 100 may include the establishment of communications protocols (protocols). Protocols may be established between all nodes of the network, including the requesting devices 101, the host devices 102 and the relay devices 103, 104, 105. A protocol may be a system of digital message formats and rules for exchanging messages between computing systems or nodes on a network 100. The protocols may describe the syntax, synchronization and semantics of the communication between the nodes. A protocol may be thought of as a commonly understood language between each node that allows each node to facilitate requesting or responding to other nodes in a manner that the other nodes will understand. Embodiments may include Transmission Control Protocol (TCP), Internet Protocol (IP), Open Systems Interconnection (OSI), AppleTalk, User Datagram Protocol (UDP), Internetwork Packet Exchange (IPX), Sequenced Packet Exchange (SPX), other commonly known or used protocols such as IEEE 802.1 standards and combinations thereof. Other protocols established may include protocols used to communicate cellular telephones or mobile devices with other computing devices. These mobile protocols may include General Packet Radio Services (GPRS), Enhanced Data GSM Environment (EDGE), Universal Mobile Telecommunication Service (UMTS), Wideband Code-Division Multiple Access (WCDMA), High-Speed Downlink Packet Access (HSDPA), Evolution Data Maximized (EVDO), Mobile WiMAX, LTE, LTE advanced, mobile broadband wireless access (MBWA), IEEE 802.20 or any other commonly used network protocols used to transfer data and communications between mobile devices or cellular telephones.

Different types of protocols may be established between different nodes. In some embodiments a single node may be equipped with a plurality of different protocols which may allow the node to communicate with specific classes of nodes on the network 100. In an exemplary embodiment, TCP/IP protocol are established between each of the nodes of the network 100.

Referring to FIG. 3, which depicts the logic and analysis of a requesting device 101 when it receives an incoming data packet 301 from another node within the remote controlled network 100 or direct user action 302. In an exemplary embodiment, a requesting device may be constantly listening for incoming data packets 301 directed to reach a port on the incoming device 101. A port may be an application specific or software specific construct which serves as a nodes point of communication with other nodes in a network. A port may be associated with an IP address of the requesting device 101 or a host device 102 and may allow for incoming or outgoing communications between networked nodes. In an exemplary embodiment, data packets may be routed across the network 100 to a specific IP address of a node. Furthermore, an exemplary embodiment may designate that each node reserve an incoming and outgoing port for every other node on the network 100.

A requesting device 101 may be responsible for interpreting two sources of incoming data packets 301 which may be received by its networked ports. The first source of incoming data packets 301 may be from direct user action 302 to the requesting device 301. In an exemplary embodiment, user actions 302 which may generate an incoming data packet 301 may include any manipulation of the features of the requesting device 101 to control or manipulate any feature on the host device 102. User actions 302 that may control or manipulate features of the host device 102 may include manipulation of functions such as opening, modifying, copying, moving, deleting, viewing, opening, saving and/or closing files stored on the host device 102. Other features that may be manipulated on the host device 102 may include activation or manipulation of peripheral devices or non-requesting nodes. For example, in one embodiment, a user action 302 may include manipulating the mouse of the host device 102 by mirroring such manipulation on the requesting device 101. In another embodiment, a user action may include activating or deactivating a camera attached to the host device 102. In yet another embodiment, a user action 302 may include manipulation of speaker volume of the host device 102 by making the adjustment requested from the requesting device 101. In an alternative embodiment, a user action may include requesting the host device 102 manipulate a networked node that is not requesting manipulation by a host device such as a television, a smart appliance or security system. In this alternative embodiment, a requesting device may manipulate the host device 102 into further manipulating the non-requesting node, such as changing television stations, modifying a thermostat temperature, or deactivating a security system.

In one embodiment, a computing system 1200 acting as a receiving device 101 may receive from an input device 1202 a request to perform an action on a host device 102. The requesting device 101 may then formulate the action requested by the input device into a data packet. The request may then be segmented into a predetermined number of packets depending on the number of relay device being used and transmitted to each relay device and the host device wherein the action is requested.

In another embodiment, once an incoming packet 301 is determined by the requesting device 101 to have originated from a user action 302 directing the requesting device 101 to manipulate the features and functions of the host device 102, the requesting device may formulate a data packet which may place the user action in the proper protocol the host device 102 and other network nodes will understand. In an exemplary embodiment, the packets are assembled into a TCP and/or IP packet. The requesting device 101 may then determine whether the requesting device 101 is submitting the data packet directly 314 to the host device 102 or whether or not a relay device is available 303. In one embodiment if there is at least one relay 103, 104, 105 available on the network 100, the requesting device may automatically segment the data packet 110 evenly amongst the number of relays plus the host device 304. In an alternative embodiment, a requesting device may submit small test packets to determine the relay capacity and latency between the requesting device 101 and the host device 102. A requesting device may segment data packets based on latency. Thus the fastest pathways to the host device may receive the largest data packets while the slowest relays may receive the smallest data packets.

In alternative embodiments, a relay may be connected to the network 100 but it may be non-responsive to the requesting device 101. Possible reason for a non-responsive relay device may include that the relay device may be reserved by the network administrator for specific user actions 302, reserved for facilitating host device 102 response packets 210, or the relay device may be inundated to capacity with prior data packets. In one embodiment the requesting device may bypass the relays and submit a data packet directly 314 to the host device. In another embodiment, the requesting device 101 may wait a predetermined amount of time for a relay device to become available for forwarding data packets 110.

A second type of incoming data packet 301 that may be received by the requesting device 101 may be a host device response packet 320. A host device response packet 320 may be a data packet 210 which originates from the host device 102 in response to a request packet 110 sent from a requesting device 101. In an exemplary embodiment, a host response packet 320 may arrive in packet segments 210a, 210b, 210c, 210d. The requesting device 101 may read the host device response packets 320 to determine whether or not each and every segment has arrived, in order to form a complete response packet 330. In one embodiment, once every segment of a host device response packet is received, the requesting device may reassemble the response packet and display the data regarding the host device's response, using an output device 1203 of a computing system 1200.

In an exemplary embodiment, the host device's response 210 may be displayed on a graphical user interface (GUI) of the requesting device 340. A GUI may be any type of user interface that allows the user to interact with nodes using images rather than text based commands. A GUI may represent information and actions as graphical icons or visual indicators. In an exemplary embodiment, The GUI may display responses to the requesting device's 101 manipulation of the host device in real time. The requesting device's GUI may accurately reflect the host device's GUI immediately upon manipulation of the host device 102. In another embodiment, the GUI may offer a user of a requesting device the ability to enter or exit a network. In addition, the GUI may display all the nodes on the network, all nodes that may be controlled and available options to the requesting device regarding peripherals that may be controlled for each requesting device.

Referring now to FIG. 4, which may depict an exemplary embodiment of the logic and analysis of a relay device 103 receiving an incoming data packet 410 from another node within the remote controlled network 100, or directly from a user input 302. In an exemplary embodiment, a relay device 103 may be constantly listening for incoming data packets 401 directed to reach a port on the relay device 103. A port may be associated with an IP address of the relay device 103 and may allow for incoming or outgoing communications between networked nodes. In an exemplary embodiment separate ports may be used for incoming data packets and outgoing data packets which may be directed by IP address to another node in the network 100.

A relay device may be capable of receiving incoming data packets 401 from three different sources. The three sources of incoming data packets 401 may include requesting device packets 402, host response packets 420 and user input packets 302. In an exemplary embodiment of the network 100, the three sources of incoming data packets may have different final destinations. A relay device 103 in an exemplary embodiment may be capable of determining and differentiating the three different sources of incoming data packets 401 which may allow for proper redirection of the incoming data packet 401 to the proper destination node.

The first source of an incoming data packet 401 may be from a requesting device 101. In an exemplary embodiment, a requesting device packet 402 may have an intended destination of a host device 102. A relay device 103 may scan an incoming data packet to upon receiving it to determine the origin and destination. In an exemplary embodiment, once a relay device 103 determines that the origin of the incoming data packet is from a requesting device and destination of the incoming data packet 401 is a host device, the relay device may classify the incoming data packet 401 as a requesting device packet 402. Accordingly, the relay device 103 may use its available resources to relay the packet 402 to the host device 102. In an alternative embodiment, a relay device may be set up not to forward certain types of incoming data packets. For example, a relay may be instructed as part of the network protocol not to forward requesting device packets 402 but rather to only forward host response packets 420. In this alternative embodiment, instead of relaying the packet to the host device, the relay device 103 may choose to ignore the request and continue listening for other incoming packets 410. One method that may help ensure that packets of data are not lost in the relay process is to have the requesting device 101 submit a test packet to a relay device. The requesting device's test packet 110 may act as a dummy file to determine, whether a relay device will forward a packet if received. The test packet may be a small packet of information, properly formatted with the network protocol, simply requesting a confirmation from the destination host device 102. Subsequently, if the requesting device 101 receives a confirmation response packet, the requesting device has confirmed that the relays 103, are properly forwarding packets to the host device 102.

The second source of incoming data packets 401 to a relay 103 may be host response packets 420. In an exemplary embodiment, a host response packet 420 may have an intended destination of one or more requesting devices 101 or a non-requesting node connected to the network. Similar to the incoming requesting device packet, a relay device 103 may scan an incoming data packet 401 to determine that the origin of the incoming data packet is a host device 102 and that the destination of the incoming data packet 401 is a requesting device or other node in the network. The relay device may act accordingly to classify the incoming data packet 401 as a host response packet 420. Accordingly, the relay device 103 may use its available resources to relay the packet 420 to the requesting device or non-requesting node. In one alternative embodiment, a requesting device 101 may request a response by the host device 102 to be sent a node other than the requesting device. Accordingly, when the relay device scans the packet, it may determine the source as the host device 102 and that the final destination is a node separate from the requesting device. The relay may then forward the packet according to the response instructions so that it reaches the proper node of the network 100.

In yet another alternative, a requesting device 101 may request a response from the host device to be delivered to multiple nodes. In one embodiment, a host device may send out a plurality of packet copies, wherein each copy one is designated for each node. In alternative embodiment, the host device 102 may dispatch a single copy of each packet segment to each relay device. The relay device 103 may use its own resources to create copies of the packet, enough for each destination node, then forward each copy to the destination node.

In an additional embodiment, a relay device may be setup not to forward certain types of incoming data packets, including host response packets 420. For example, a relay may be instructed as part of the network protocol not to forward host response packets but instead to exclusively forward requesting device packets 402. In this alternative embodiment, instead of relaying the packet to the requesting device, the relay device 103 may choose to ignore the request and continue listening for other incoming packets 410. One method that may help ensure that packets of data are not lost in the relay process is to have the host device 102 submit a test packet to a relay device. The requesting device's test packet 110 may act as a dummy file however, the host device 102 may include an instruction requesting a return receipt once the packet has been forwarded. Subsequently, if the host device 102 receives a receipt packet, the host device 102 has confirmed that the relay 103, are properly forwarding packets to the requesting device or other nodes.

The third source of incoming data packets 401 may be direct user input 302 such as from an input device 1203 in a computing system. As stated previously, any node within a network may change designations depending on the current function of node. A relay may be a computing system 1200 and may be able to receive input from a user directly manipulating the functions and features of the relay device 103 such as through the input device 1203 of the relay device 103. In some embodiments, a relay device may also be used to manipulate a host device 103. When an incoming data packet directed from the user requests manipulation of a host device function, relay device may at that point in time be considered a requesting device 101. Acting as a requesting device, the relay device may formulate the incoming data packet 401 into a data packet 110 suitable for being recognized by the protocol of the host device 102 and other network nodes. In this embodiment, the relay device acting as a requesting device may further segment packets and submit the packets to the host device 102 and other relays in a fashion similar to the previously described methods of a requesting device 101.

Referring now to FIG. 5 which depicts an exemplary embodiment of the logic and analysis of a host device 102 receiving an incoming data packet 501. A host device 102 may respond to packets originating from a requesting device packet 502 by performing the requested action and generating a response packet. In an exemplary embodiment, a requesting device packet 502 may be segmented depending upon the number of relay devices available and/or the resource capabilities of a relay device 103. In an exemplary embodiment, the host device 102 may scan the requesting device packet segments to determine if all segments have been received. One every packet has been received; the host device may reassemble the packet segments back into the original pre-segmented data packet. The host device may then read the entire instruction or request from the requesting device 101. In an exemplary embodiment, the host device fulfills the instructed request and may subsequently make adjustments to the host device's own files, peripherals, system and/or generated output in accordance with the request of the requesting device. In addition, the host device in an exemplary embodiment may transmit a generated response to the requesting device and/or a non-requesting node. The response may accurately display or reflect the current status of the host device on the requesting device or non-requesting node. For example, a requesting device may view a file opened on the host device and wish to close the file. The request is submitted to the host device to close the file. Subsequently upon receiving the request, the host device closes the file, then forwards the status of the file as closed to the requesting device 101. Whereupon the requesting device receives the response, the requesting device now accurately perceives the closed file as closed. The responses are clearly not limited to opening and closing files but rather in an exemplary embodiment, this method of controlling a host device and accurately reflecting those changes on the requesting device may conducted for any function that may be manipulated by the requesting device.

Referring to FIG. 6 which depicts an alternative embodiment featuring a network 600. In this alternative embodiment, the network 600 is handling two simultaneous requests from two separate requesting devices 601, 620. The first requesting device 601 and the second requesting device 620 may each act in accordance with embodiments previously described for an individual requesting device 101. The first requesting device 601 may segment its incoming user directed action into multiple data packet segments 610a, 610b, 610c, 610d. Each data packet segment may be designated for host device 602. In order to increase the total throughput and capabilities of the network 600, the requesting device 601 may employ relay device 603 and 604 to forward data packets 621b and 621c to the host device 602. In addition, a requesting device may send packet segment 610a directly to the host device 602 itself. Furthermore, in the embodiment of network 600, the second requesting device 620 may be employed to act simultaneously as a requesting device and a relay device. The requesting device 620 may use a dedicated port for incoming packets to receive requesting device's 601 incoming data packet 610d. Subsequently, acting in its capacity as a relay, requesting device 620 may use its available resources to forward packet 610d to host device 602.

While requesting device 620 may act as a relay for requesting device 601, in an exemplary embodiment, requesting device 620 may also simultaneously acts as a requesting device. In this regard, requesting device 620 may receive and segment separate user action data packets from the one received by requesting device 601. In an exemplary embodiment, the requesting device 620 may utilize outgoing ports to transfer the data packet segments 621b and 621c to relay devices 603 and 604. The requesting device 620 may also act similarly to requesting device 601. Requesting device 620 may directly submit data packet 621a directly to the host device 602. In addition, requesting device 620 may also employ requesting device 601 to act simultaneously as a relay device and thus utilize its own resources to forward data packet 621d to host device 602, while at the same time acting as a requesting device.

As depicted, relay devices 603 and 604 may receive multiple simultaneous incoming data packets. In an exemplary embodiment, the relay devices may have adequate resources to receive and transmit a plurality data packets parallel to each other. One method for achieving a parallel processing of data packets may be to designate incoming and outgoing ports specifically for each node of the network 600. This may ensure that the relay device is able to listen for and respond to communications from every node on the network simultaneously without forming a queue of data packets.

Alternatively, in another embodiment, a relay device may have an established protocol for processing multiple simultaneous data packet requests. In one embodiment, the relay device 603 and 604 may process and forward the data packets based on the order in which the packets arrive. In another embodiment, the data packets may be addressed in a designated hierarchy. For example, requesting device 601 may have priority to the relay devices. Accordingly, a relay device 603 and 604 may arrest the processing and forwarding of requesting device 620's packets 621b, 621c, in order to accept, process and forward requesting device 601 packets first. In yet another alternative embodiment, each relay device may be set up according to a different protocol hierarchy. Another possible embodiment may include a protocol which may require a relay device 603 and 604 to reject additional incoming packets when the relay 603, 604 are currently in the process of forwarding data packets. In this possible embodiment, relays 603 and 604 may only process and forward one packet segment at a time, and thus may be unresponsive while actively forwarding packet segments

In an exemplary embodiment, host device 602 may receive and submit responses to the requesting devices 601 and 620 simultaneously. The host device 602 may achieve simultaneous receipt of all data packets by dedicating an incoming port for each node on the network 600. In the alternative, the host device may receive incoming packets 610, 621 on a first come first serve basis. In an exemplary embodiment, once the host device 602 receives simultaneous requests, it may apportion resources as necessary to complete each request from a requesting device 601, 620 simultaneously. In one embodiment, apportionment of resources may be split evenly between each request. In another embodiment, each request may receive resources devoted to it based on the size, complexity and intensity of processing necessary to respond.

In the event that requesting devices 601 and 620 both request to manipulate the same function, file, or peripheral of the host device, the host device may be instructed to compare the requests to determine whether separate files, functions, features or peripherals are sought to be manipulated. In an exemplary embodiment, if there is a conflict between the first request 610 and the second request 621, the manipulation may occur in the order in which the requests are received. In an alternative embodiment where two separate requests intend to manipulate the same file, a host device may create a duplicate file which may be manipulated separately from the original file. This may alleviate conflicting manipulations by each requesting device 601, 620.

Referring to FIG. 7 which depicts an alternative embodiment of a network 700. Network 700 is depicting one possible scenario wherein requesting devices 701 and 720 may be tasked by a user of each requesting device to manipulate two separate host devices 702 and 712 simultaneously. In this embodiment five nodes are presented, however as previously shown, a network 700 may include more or less nodes. Furthermore, while network 700 only depicts two simultaneous requests, any number of simultaneous requests from requesting devices may be present. In an exemplary embodiment of network 700 a first requesting device 701 may assemble a user request packet into a data packet of the proper network protocol 710. The requesting device may then segment the data packet into a series of segments 710a, 710b, 710c. In the network 700, requesting devices may directly submit a packet 710a to the designated host device 702. In addition, the requesting device may also utilize the resources of other nodes in the network 700. The first requesting device 701 may forward the remaining packet segments 710b and 710c to other devices capable of acting as relays.

In the embodiment of FIG. 7, the first requesting device 701 may employ requesting device 720 and relay device 703. In an alternative embodiment, the requesting device may further choose to use the other remaining node device, which is host device 712, to assist in forwarding the packet to host device 702 because host device 712 may be capable of acting as a relay and thus contribute its resources to the resource pool.

In an exemplary embodiment of network 700, a separate request may occur from a network user on a second requesting device 720. The second requesting device 720 may assemble the second request into a data packet 721 which may comply with the network protocol such that it will be understood by the other nodes of network 700. The second requesting device 720 may calculate the optimal number of segments needed to forward the entire data packet 721 to the designated node for manipulation, host device 712. In one embodiment, the second requesting device may divide the data packet 721 into three segments 721a, 721b, 721c. The second requesting device 720 may forward a data packet directly to host device 712, and/or it may employ other nodes as relays. In the embodiment of network 700, the second requesting device is forwarding the packet segments 721b and 721c to relay device 703 and the first requesting device 701 (which is capable of acting as a relay device) respectively as well as employing the method of directly submitting at least one packet segment 721a to the host device 712.

In an exemplary embodiment of network 700, relay device 703 is capable of forwarding multiple packet segments 710b and 721b from separate sources to multiple host devices 702 and 712. In an exemplary embodiment, the relay device 703 is capable of receiving, sorting and forwarding multiple packet segments 710, 712 simultaneously. One method for achieving such a technical feat is through the use of ports dedicated on the relay for each node of the network 700. Relay device 703 may listen for and receive incoming data packets from separate nodes simultaneously on each separate port. The relay device 703 may then scan or read the data packets 710b, 721b for directions regarding the destinations of each packet segment simultaneously by allocating resources between the two tasks. The relay device 703 may also forward each packet segment 710b, 721b through separate outgoing ports dedicated to host device 702, 712.

Referring to FIG. 8, network 800 depicts an alternative embodiment wherein a single requesting device 801 receives instructions from a user to manipulate the functions of two host devices 802, 812 simultaneously. Requesting device 801 may convert the user action requesting manipulation of a host device into a data packet 810 which may be in a format that follows the protocol of each node in network 800. In one embodiment, the requesting device may make a copy of the data packet 810 prior to segmenting the data packet into segments 810a, 810b. In an alternative embodiment, requesting device 801 may segment the data packet 810 into packet segments 810a, 810b and then make copies of each data packet segment individually. Once the requisite number of packet segments 810a, 810b are prepared for each separate host device 802, 812 the requesting device 801 may forward the respective packets to each relay device 803, 804. In one embodiment, relay device 803, 804 may be reserved specifically for using their resources to process and forward packets to a specific host device 802, 812. As depicted in FIG. 8, relay device 803 may be reserved specifically to forward packet 810b to host device 802, while relay device 804 may forward packet 810b to host device 812 exclusively.

In an alternative embodiment, requesting device 801 may segment the data packet 810 into three segments, 810a, 810b, 810c (not shown). Subsequently, each relay device 803, 804 may receive a single data packet segment and then be tasked with copying the data packet segment a designated number times based on the number of host device's the requesting device 801 may specify the relay device forward the data packet to. The relay device 803, 804 may use its resources to copy the data packet segment the requisite number of times and forward the data packet segment to each of the host devices 802, 812.

Referring to FIG. 9, network 900 depicts an alternative embodiment wherein a plurality of requests are submitted to a host device 902 through dedicated relay devices 903, 904, 905, 906. In an exemplary embodiment, the first requesting device 901, may receive an incoming data packet from a user requesting a specific action to manipulate a host device 902. The requesting device 901 prepares the data packet 910 in a format understood by the other nodes in the network 900. In one embodiment, the requesting device 901 may attempt to determine the number of available relays 903, 904 which are accessible. As previously discussed, unavailable relays 905, 906 may be programmed with instructions to ignore incoming data packets from the first requesting device 901. In an alternative embodiment, relay device 905, 906 may only be temporarily designated to forward packets from the second requesting device 920. Relays 905, 906 may resume packet forwarding for other network nodes once the process of forwarding packets 921a, 921b has completed.

Subsequently, the first requesting device 901 may attempt to test which relays are available through methods previously discussed, such as forwarding test packets or through other means known in the networking industry for testing availability of a network node. As a result of testing, the first requesting device 901 may determine that only certain relays are available 903, 904 at the point the requesting device 901 wishes to forward the packets 910a, 910b, 910c. Thus the first requesting device may segment data packet 910 into 3 segments, one segment for each available relay 903, 904 and one data packet segment 910a which may be transferred directly to host device 902.

A second requesting device 920 may receive a request to manipulate the same host device 902 as the first requesting device 901, in close temporal proximity or simultaneously to the point in time at which the first requesting device receives the first user request. The second requesting device may independently perform the same actions as requesting device 901 to forward the data packet 921 to host device 902 using available relays 905, 906 which may be designated as reserved for the second requesting device 920 or may be the only relays not currently being used by the first requesting device.

In an embodiment wherein the relay devices of a network are only capable of fulfilling one request at a time, at least one relay from the plurality of relays may be designated for each node on the network that may become requesting device. This may ensure that at any given time at least one relay is available to the requesting device. Alternatively, a network protocol may be set up to limit the total number of relay devices or percentage of relay devices that each requesting device may occupy at a single time, thus a reserve supply of relay devices may be available to ensure that any one request does not take a suboptimal amount of time to reach a host device.

In an exemplary embodiment, host device 902 may receive each packet segment 910a, 910b, 910c, 921a, 921b, 921c, simultaneously. A host device may designate an incoming port for each node of network 900, thus host device 902 may receive, process and analyze each packet segment simultaneously. In an exemplary embodiment, upon receiving each packet segment 910 and 921, host device 902 may compare the requests to determine whether or not the requests for manipulation may conflict with each other. If the requests for manipulation do not conflict, the host device 902 may perform each requested manipulation simultaneously and return a separate response to each requesting device 901, 920. If on the other hand, the host device 902 makes the determination that the requests may conflict, the host device may be programmed with a method to resolve the conflict. Examples of conflict may include simultaneous requests to: open and delete a file, move a file to another location and open the file from the previous location, modify a file two ways that are not compatible with each other or any other type of manipulations that one skilled in the art would recognize as conflicting. A host device 902 may attempt to alleviate such conflicts.

In one embodiment, a host device may make copies of files that are being used simultaneously by user in order to prevent conflicts. In another embodiment, the host device 902 may simply fulfill the requests for manipulation in the order in which the requests are received, for example if two separate requests are made to adjust the location of a peripheral such as a cursor, the first request may be made to adjust the peripheral to the designated position followed by subsequent change in cursor position.

In an alternative embodiment, a host device may fulfill the first request received without regard for the second request for manipulation. In this regard if there is a conflict wherein the second request is no longer possible, the host device 902 may respond to the second requesting device 920 with an error message providing the user with information regarding the conflict.

In yet an alternative embodiment, a host device being manipulated by a plurality of requesting devices may create a separate virtual copy of all files, display one environment for the first requesting device 901 and a second environment that is an exact replica of all files accessible by the first requesting that may be accessed by the second requesting device 920 as of the point in time that the second requesting device begins submitting requests for manipulation. The host device 902 may subsequently save a separate copy of any conflicting files and merge changes that do not conflict with the files manipulated by the first requesting device 901.

Referring to FIG. 11, network 1100 depicts an alternative embodiment of a remote controlled network wherein a requesting device 1101 may manipulate a host device 1102. In contrast to network 100, network 1100 protocol may regulate and optimize the flow and direction of request packets 1110 and response packets 1120. In an exemplary embodiment, an equal number of relay devices 1103, 1104, 1105, 1106 may be designated as request relays 1105, 1106 and response relays 1103, 1104. One advantage of organizing the flow of packets may be to optimize resources such as network throughput to achieve the fastest latency between requesting device 1101 and host device 1102 as possible. Another advantage to this embodiment may be that a host device 1102 may always have at its disposal a relay device capable of contributing resources to a resource pool which may allow responses to the requesting device 1101 as fast as new requests are being made without extended amounts of latency.

In an alternative embodiment, relay devices may divided between forwarding requests to the host device 1102 and forwarding responses to the requesting device 1101 based on optimizing latency from request to response. A network 1100 may feature a configuration mode which tests various configurations of relay devices and calculates to the total latency time. Because each relay device may not be identical in terms of available resources, a network determining the optimal configuration may not simply focus on the number of available relays but also the quality of the relay device and its available resources in determining optimal latency configurations.

While this invention has been described in conjunction with the specific embodiments outlined above, it is evident that many alternatives, modifications and variations will be apparent to those skilled in the art. Accordingly, exemplary embodiments of the invention as set forth above are intended to be illustrative, not limiting. Various changes may be made without departing from the spirit and scope of the invention as defined in the following claims. The claims provide the scope of the coverage of the invention and should not be limited to the specific examples provided herein.

What is claimed is:

1. A method for remotely accessing a computing device in real time comprising:
establishing, by a processor of a computing system a protocol between at least two network nodes;
receiving, by the processor, a request by an input device of the computing system;
segmenting, by the processor, the request into a predetermined number of packets;
transmitting, by the processor, the request to the at least two network nodes;
receiving, by the processor, a predetermined number of response packets from the at least two network nodes;
reassembling, by the processor, the predetermined number of packets into a response from at least one of the at least two network nodes; and
displaying, by the processor, the response from at least one of the at least two network nodes.

2. The method of claim 1, wherein the protocol is selected from a group consisting of Transmission Control Protocol (TCP), Internet Protocol (IP), Open Systems Interconnection (OSI), AppleTalk, User Datagram Protocol (UDP), Internetwork Packet Exchange (IPX), Sequenced Packet Exchange (SPX), Enhanced Data Rates for GSM Evolution (EDGE), Universal Mobile Telecommunications System (UMTS), Digital Enhanced Cordless Telecommunications (DECT), Digital AMPS (IS-136/TDMA), Integrated Digital Enhanced Network (iDEN), WiMAX, LTE, LTE advanced, mobile broadband wireless access (MBWA), IEEE 802.20 and combinations thereof.

3. The method of claim 1, wherein the at least two network nodes are computing systems selected from the group consisting of personal computers, laptop computers, tablet computers, servers, cellular telephones, smart televisions, video game consoles and a combination thereof.

4. The method of claim 1, comprising an additional step of assigning, by the processor, at least one of the at least two network nodes as a peripheral device.

5. The method of claim 4, wherein the peripheral device is selected from a group consisting of a mouse, keyboard, monitor, controller, hard drive, storage device, speaker, printer, CD-ROM, modem and a combination thereof.

6. The method of claim 1, wherein the step of transmitting, by the processor, further includes consuming resources, by the computing system, from at least one of the at least two network nodes.

7. The method of claim 6 wherein resources are selected from a group consisting of a central processing unit (CPU), random access memory (RAM), virtual memory, hard disk space, network throughput, electrical power and a combination thereof.

8. The method of claim 4, wherein at least one of the at least two network nodes is assigned as a peripheral device selected from the group consisting of a mouse, keyboard, monitor and a combination thereof.

9. The method of claim 1 wherein the request to the at least two network nodes includes manipulating a file of at least one of the at least two network nodes.

10. The method of claim 9 wherein the manipulation is selected from the group consisting of opening, modifying, copying, moving, deleting, closing and a combination thereof.

11. The method of claim 1 wherein the step of establishing, by a processor, the protocol, establishes a private network connection between the at least two network nodes and the computing system.

12. The method of claim 1 wherein the step of displaying, by the processor further includes displaying via a graphical user interface.

13. A method for remotely accessing computing devices comprising:
establishing, by a processor of a computing system, a protocol between at least two network nodes;
receiving, by the processor, at least two packet segments generated by at least one of the at least two network nodes;
reassembling, by the processor, the at least two packet segments into a request from at least one of the at least two network nodes;
performing, by the processor, the request from at least one of the at least two network nodes;
generating, by the processor, a response packet;
segmenting, by the processor, the response packet into a predetermined number of packet segments; and
transmitting, by the processor, at least one of the predetermined number of packet segments to each of the at least two network nodes.

14. The method of claim 13 wherein the protocol is selected from a group consisting of Transmission Control Protocol (TCP), Internet Protocol (IP), Open Systems Interconnection (OSI), AppleTalk, User Datagram Protocol (UDP), Internetwork Packet Exchange (IPX), Sequenced Packet Exchange (SPX), WiMAX, LTE, LTE advanced, mobile broadband wireless access (MBWA), IEEE 802.20 and combinations thereof.

15. The method of claim 13 wherein the at least two network nodes are selected from a group consisting of personal computers, laptop computers, tablet computers, servers, cellular telephones, smart televisions, video game consoles and a combination thereof.

16. The method of claim 13, wherein the step of transmitting, by the processor, further includes consuming resources, by the computing system, from at least one of the at least two network nodes.

17. The method of claim 16 wherein resources are selected from a group consisting of a central processing unit (CPU), random access memory (RAM), virtual memory, hard disk space, network throughput, electrical power and a combination thereof.

18. The method of claim 13 wherein the step of performing the request, by the processor, includes manipulating a file stored on the computing system.

19. The method of claim 13 wherein manipulating is selected from the group consisting of opening, modifying, copying, moving, deleting, closing and a combination thereof.

20. A system for remotely accessing computing devices in real time comprising:
at least three node devices communicating via a network;
a pool of resources wherein said pool of resources are utilized by at least one of the at least three node devices communicating with each other; and
at least one of the at least three node devices is manipulating another of the at least three node device.

21. The system of claim 20 wherein the at least three node devices are selected from a group consisting of personal computers, laptop computers, tablet computers, servers, cellular telephones, smart televisions, video game consoles and a combination thereof.

22. The system of claim 20 wherein the system further comprises at least one graphical user interface.

23. The system of claim 22 wherein the graphical user interface allows a user of at least one of the at least three node devices to select another node device of the at least three node devices to manipulate.

24. The system of claim 20 wherein at least one of the at least three node devices is assigned as a peripheral device of another of the at least three node device.

25. The system of claim 22 wherein the graphical user interface allows at least one of the at least three node devices to assign itself as a peripheral device of another at least three node device.

26. The system of claim 24 wherein the peripheral device is selected from a group consisting of a mouse, keyboard, monitor, controller, speaker, printer, CD-ROM, modem and a combination thereof.

27. The system of claim 20 wherein at least two of the at least three node devices are manipulating the same at least one of the at least three node devices.

28. The system of claim 20 wherein the network is selected from a group consisting of Wi-Fi, Bluetooth, LAN, WAN, intranet, internet, extranet, IEEE 802.1x, WiMAX, LTE, LTE advanced, mobile broadband wireless access (MBWA), IEEE 802.20 and combinations thereof.

29. The system of claim 20 wherein the at least three node devices share a private network.

30. The system of claim 20 wherein the pool of resources are selected from a group consisting of central processing units (CPU), random access memory (RAM), virtual memory, hard disk space, network throughput, electrical power and combinations thereof.

31. A system for remotely accessing computing devices in real time comprising:
at least three node devices communicating via a network; and
at least one graphical user interface identifying each of the at least three node devices communicating via the network, wherein at least one of the at least three node devices manipulates another node of the at least three node devices through the graphical user interface.

32. The system of claim 31 wherein the at least three node devices are selected from a group consisting of personal computers, laptop computers, tablet computers, servers, cellular telephones, smart televisions, video game consoles and a combination thereof.

33. The system of claim 31 wherein the network is selected from a group consisting of Wi-Fi, Bluetooth, LAN, WAN, intranet, internet, extranet, IEEE 802.1x, WiMAX, LTE, LTE advanced, mobile broadband wireless access (MBWA), IEEE 802.20 and a combination thereof.

34. The system of claim 31 wherein at least one of the at least one graphical user interfaces is displayed on an output device.

35. The system of claim 31 wherein at least one of the at least one graphical user interfaces is displayed on a cellular telephone.

36. The system of claim 31 wherein the system further includes at least one of the at least three node devices assigned as a peripheral device of another of the at least three node devices.

37. The system of claim 36 wherein the at least one of the at least three node devices selects the peripheral device from the graphical user interface.
